(19) United States
(12) Patent Application Publication
(10) Pub. No.: US 2004/0073510 A1
(43) Pub. Date: Apr. 15, 2004

(54) Automated method and exchange for facilitating settlement of transactions

(76) Inventor: Thomas D. Logan, Alamo, CA (US)

Correspondence Address: SKADDEN, ARPS, SLATE, MEAGHER & FLOM LLP, ATTN: JAN STEELE, 525 UNIVERSITY AVENUE, SUITE 1100, PALO ALTO, CA, 94301, US

(21) Appl. No.: 10/608,307

(22) Filed: Jun. 26, 2003

Related U.S. Application Data
(60) Provisional application No. 60/392,471, filed on Jun. 27, 2002.

(51) Int. Cl. G06F 17/60

(52) U.S. Cl. 705/40

(57) ABSTRACT

A system and method are described for settling transactions between supply-chain participants which greatly simplifies the accounts payable, credit, and collections processes for participants, and provides them with unique capabilities to modify terms-of trade and the resultant cash flows in a mutually beneficial fashion by managing the gap between marginal borrowing rates.

### CROSS REFERENCE TO RELATED APPLICATION

This application claims the benefit of U.S. Provisional Application No. 60/392,471, filed Jun. 27, 2002.

### FIELD OF INVENTION

The present invention relates to financial settlements. More particularly, the present invention concerns an automated method and system for facilitating settlement of transactions between parties with differences in their marginal cost of funds.

### BACKGROUND

Traditional financial settlement activities between buyers and sellers of goods and services have been fraught with inefficiencies, leading to high-cost manual intervention within both the invoicing-credit-collections process and the procurement-accounts payable process. Financial EDI, utilizing ANSI X.12 transaction sets, EDIFACT transaction sets, or other customized protocols have been minimally successful, due to the high cost of agreeing on specific bilateral protocols. Spontaneous EDI has therefore remained an elusive vision, albeit one that promises greater supply chain efficiency, and lower administrative costs for the participants.

A related issue in supply chain settlement is differential terms of trade. Terms of trade is a generic term covering the formatting of invoice information; the period of time between the provision of goods or services and the time payment is due; discounts for early payment; the type of payment; the currency of payment; the required locations for directing payments and remittance information; etc. Generally speaking, larger entities dictate terms of trade to smaller entities, who are typically suppliers. Paradoxically, smaller entities are often poorly equipped to comply with the terms of trade dictated by larger customers, and expend incremental compliance costs that significantly exceed the incremental value enjoyed by the larger entity.

This phenomenon is most apparent when differential borrowing costs are evaluated. A large investment-grade corporation is likely to have the ability to borrow incremental funds at or near LIBOR (i.e., the London Interbank Offer Rate). A sub-investment grade supplier, however, often has a marginal cost of funds that exceeds LIBOR by 4 or 5%. When a large customer dictates a lengthy period of time between receipts of goods or services and the related payment, supply chain inefficiency is created. This is due to the fact that the sub-investment grade supplier must incur borrowing costs that significantly exceed the value enjoyed by the investment-grade customer. In other words, that 4-5% borrowing differential represents value that could be shared by the buyer and the seller by accelerating the payment due date in exchange for a reduced purchase cost.

There have been previous attempts to fix these supply chain inefficiencies.

For example, U.S. Pat. No. 6,167,385 describes a supply chain financing system and method. For this method, “the buyer generates a purchase order for the goods that is forwarded to the supplier who, in turn, ships the goods to the buyer. The supplier sends an invoice to the buyer, who stores the invoice data in a database. A financing institution (e.g., a bank) electronically accesses the database to retrieve the daily invoices. The financial institution then calculates the financing applicable to the shipped good and forwards a payment to the supplier. Upon maturity of the financing, the buyer settles with the financial institution by remitting the gross proceeds.”

The system and method described in U.S. Pat. No. 6,167,385 suffers from numerous deficiencies and shortcomings.

The setup process is quite cumbersome, time consuming, and costly. According to the patent:

“Prior to actually implementing the [method], the parties involved must evaluate the potential saving which can be expected. . . . This evaluation process typically begins with the buyer hiring the [bank]. . . . The [bank] reviews the electronic commerce infrastructure among the buyer and its trading partners. . . . If the above evaluation determines that there is sufficient financial benefit, the bank makes recommendations on the structure and implementation approach, taking into account the client's relationships with its trading partners and the client's other non-financial objectives. The [bank] conducts interviews with the trading partners in order to validate the supply chain assumptions used . . . and to understand other non-financial objectives and business values which may impact the implementation. . . . If the results of the interviews are all favorable, and the parties agree to proceed, there are several technical, administrative and legal processes which must be established. . . . The buyer in conjunction with the [bank] determines the advance financing rates which are applicable for each of the participating vendors.”

In addition, the advance financing rates that the buyer and the bank determine for each seller (vendor) are not based on differences in buyer-specified and seller-specified cost of funds.

Moreover, there is always financial intervention between the buyer and the seller by a third party (e.g., a bank). The bank puts its own funds at risk by paying the seller prior to receiving payment from the buyer upon maturation of the underlying financing. Consequently, the benefits that the buyer and/or seller receive are reduced by the costs of having the bank act as a financial intermediary. These costs for financial intervention by a third party will be greater than the costs that the buyer and seller typically would incur by using a computerized exchange to propose modifications to the payment terms of a transaction between the buyer and the seller and/or modify the transaction. In other words, the fees charged by a bank acting as a financing intermediary will be greater than the fees charged by an exchange acting as an information intermediary.

In another example, U.S. Patent Application Publication US 2002/0082985 describes: “a method and system for processing a Purchaser's existing or future trade credit obligations (which are commonly referred to as “accounts payable” or “trade payables”) in a manner that (i) converts such existing or future trade credit obligations into a new obligation, and (ii) provides financial and other benefits to a Purchaser. More specifically, . . . a Funding Company [(e.g., a bank)] and a Purchaser enter into an agreement pursuant to which a mechanism is established under which the Purchaser's Suppliers are offered the opportunity to obtain the prompt or accelerated payment of the Purchaser's existing or future trade credit obligations to them in exchange for providing percentage discounts, which are commonly referred to as “prompt payment discounts,” from such trade credit obligations. Suppliers may bargain or bid for prompt or accelerated payment under the mechanism that is established by offering prompt payment discounts with respect to such trade credit obligations. Pursuant to the Agreement, the Funding Company pays the discounted price of the trade credit obligation on behalf of the Purchaser, and the Purchaser pays the Funding Company a higher amount than the discounted price of such trade credit obligation, up to the full face value of such trade credit obligation, at an agreed upon future date.”

Like U.S. Pat. No. 6,167,385, U.S. Patent Application Publication US 2002/0082985 is quite cumbersome, time consuming, and costly. It uses an auction to determine the prompt payment discount for each transaction, rather than using the buyer and seller's cost of funds. Thus, the system does not propose modifications to purchase orders based on differences in the buyer and seller's cost of funds or implement such modifications.

In another example, U.S. Patent Application Publication US 2002/0099655 describes a system that facilitates seller financing and advance payment. This system also allows buyers and sellers to amend purchase order agreements.

However, the type of seller financing that is facilitated by this system is just the conventional use of a third party financial intermediary, e.g., the seller “obtains advance payment from a lender who . . . then become[s] entitled to payment from the buyer.” Thus, potential benefits to the buyer and/or seller are reduced by the costs paid to the financial intermediary. In addition, the system does not receive or evaluate the cost of funds for either the buyer or the seller. Thus, the system does not propose or implement amendments to purchase orders based on differences in the buyer and seller's cost of funds.

In another example, U.S. Patent Application Publication US 2003/0018563 describes a method and system for facilitating financial investment in the trading and processing of commercial accounts receivable. Like the other prior art cited above, U.S. Patent Application Publication US 2003/0018563 is quite cumbersome, time consuming, and costly. It uses a dynamic trading process (e.g., an auction) to determine the discount to be applied to each account receivable. Like U.S. Patent Application Publication US 2002/0099655, the system does not receive or evaluate the cost of funds for either the buyer or the seller. Consequently, this system also does not propose modifications to purchase orders based on differences in the buyer and seller's cost of funds or implement such modifications.

### SUMMARY OF THE INVENTION

The present invention overcomes the limitations and disadvantages of the prior art by providing an automated method and system for facilitating settlement of transactions between parties with differences in their marginal cost of funds.

One aspect of the invention involves a method in which a computerized financial settlement exchange receives a buyer's cost of funds, a seller's cost of funds, and one or more payment terms of a transaction. The exchange determines whether the transaction is eligible for modification based at least in part on the buyer's cost of funds, the seller's cost of funds, and one or more of the payment terms. If the exchange determines that the transaction is eligible for modification, the exchange proposes that one or more of the payment terms be modified and/or modifies the payment terms.

In one embodiment, the modification does not involve financial intervention by a third party, such as a bank providing financing.

Another aspect of the invention involves a system that implements a financial settlement exchange.

Another aspect of the invention involves a machine readable medium with stored data thereon that represent sequences of instructions for operating the exchange.

The current invention differs from the prior art because it does not require a third party (typically a financial institution) to mediate transactions and provide financing to participants. Rather, the participants typically provide trade credit to one another, which may be extended or truncated based upon the relative borrowing and/or investment rates of the participants, and the liquidity preferences of the participants.

The benefits of the invention would accrue to all participants, and would include: lower accounts payable administration costs, lower accounts receivable and credit administration costs, lower banking costs, the ability to accelerate liquidity in a fashion that simultaneously increases profits, the ability to defer liquidity in a fashion that simultaneously increases profits, reduced borrowing costs, increased investment returns, greater borrowing availability, improved return on capital employed, and favorable accounting characterization.

In addition, as the number of participants in the exchange grows, “spontaneous EDI” will become possible and practical. The exchange will benefit by earning banking fees, participation fees, transaction fees, and discount fees. Moreover, the exchange will benefit by gaining a unique knowledge of the transaction patterns of its participants, thereby giving it a unique ability to expand the supply chain offerings to participants.

The foregoing and other embodiments and aspects of the present invention will become apparent to those skilled in the art in view of the subsequent detailed description of the invention taken together with the appended claims and the accompanying figures.

### DESCRIPTION OF DRAWINGS

FIG. 1 is a schematic diagram illustrating two exemplary system interfaces between a participant and the financial settlement exchange, i.e., via an ERP system and via a customer interface module.

FIG. 2 is a schematic diagram illustrating certain exemplary components of the user interface to the financial settlement exchange.

FIG. 3 is a flow chart of an exemplary process for facilitating settlement of transactions between parties with differences in their marginal cost of funds.

FIG. 4 is a schematic diagram illustrating the flow of information and funds between participants and the financial settlement exchange for a strong buyer/weak seller scenario.

FIG. 5 is a schematic diagram illustrating the flow of information and funds between participants and the financial settlement exchange for a weak buyer/strong seller scenario.

### DETAILED DESCRIPTION

A method and system are described for facilitating settlement of transactions between parties with differences in their marginal cost of funds. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well-known to those of ordinary skill in the art are not described in detail to avoid obscuring aspects of the present invention.

Different sources often give financial terms somewhat different meanings or scope. THUS, IN THE SPECIFICATION AND CLAIMS, THE DEFINITIONS SET FORTH BELOW SHALL BE CONTROLLING.

buyer—Any entity that purchases goods and/or services from a seller. The buyer typically takes delivery of the goods or services prior to paying the seller using trade credit.

cost of funds—The marginal borrowing rate or marginal investment rate of a participant, as applicable.

credit limit—The maximum amount of trade credit that a seller is willing to extend to a buyer.

entity—An entity can be any person, institution, company, corporation, partnership, government agency, or university.

ERP system—An enterprise resource planning system, i.e., the computer applications and systems used to manage an entity's procurement and financial transactions.

financial intervention—Occurs when a third party (e.g., a financial institution such as a bank) provides financing for a transaction between a buyer and a seller.

financial settlement exchange (“exchange”)—A computer system that facilitates financial settlements by: receiving a buyer's cost of funds, a seller's cost of funds, and one or more payment terms of a transaction; determining whether the transaction is eligible for modification based at least in part on this received information; and proposing a modification to one or more of the payment terms and/or modifying one or more of the terms.

The exchange will also typically consider other information, such as the liquidity preferences of the buyer and seller, when it determines whether a transaction is eligible for modification. The exchange will also typically implement the modification without financial intervention by a third party (e.g., a bank).

In most cases, the exchange computer system will be part of an entity that does business with multiple buyers and multiple sellers, but which is a separate entity from any particular buyer or seller. However, it is also possible for the exchange to be part of a particular buyer or seller. For example, a strong buyer could setup and operate a financial settlement exchange with its sellers. Conversely, a strong seller could setup and operate a financial settlement exchange with its buyers.

The exchange computer system includes a machine readable medium with stored data thereon that represent sequences of instructions for operating the exchange.

forfait—The process of purchasing accounts receivable from a seller on a non-recourse basis, and financing the purchase through an external source of funds.

initial terms—The terms of trade (e.g., payment due date, form of payment, prompt pay discount, etc.) agreed to at the time a transaction is entered into.

liquidity preferences—The stated desires of participants to either accelerate or decelerate cash flows in exchange for decreased or increased profits.

marginal borrowing rate—The incremental or marginal interest rate associated with short term borrowing. This rate is preferably a self-specified rate determined by the borrower, which the participant may amend from time to time. There is a strong incentive for participants to accurately state this rate, as overstatement or understatement will either limit economically attractive opportunities for transaction modification or cause economically unattractive transaction modifications to occur.

marginal investment rate—The incremental or marginal interest rate associated with short term investments. This rate is preferably a self-specified rate determined by the investor, which the participant may amend from time to time. There is a strong incentive for participants to accurately state this rate, as overstatement or understatement will either limit economically attractive opportunities for transaction modification or cause economically unattractive transaction modifications to occur.

participant—A party to a transaction, i.e., a buyer or a seller.

seller—Any entity that sells goods and/or services to a buyer.

trade credit—Credit extended by a seller to a buyer that permits the buyer to pay the seller at a future date, e.g., 30 days after receipt of goods. Trade credit is generally capped by credit limits.

transaction—A purchase of goods and/or services.

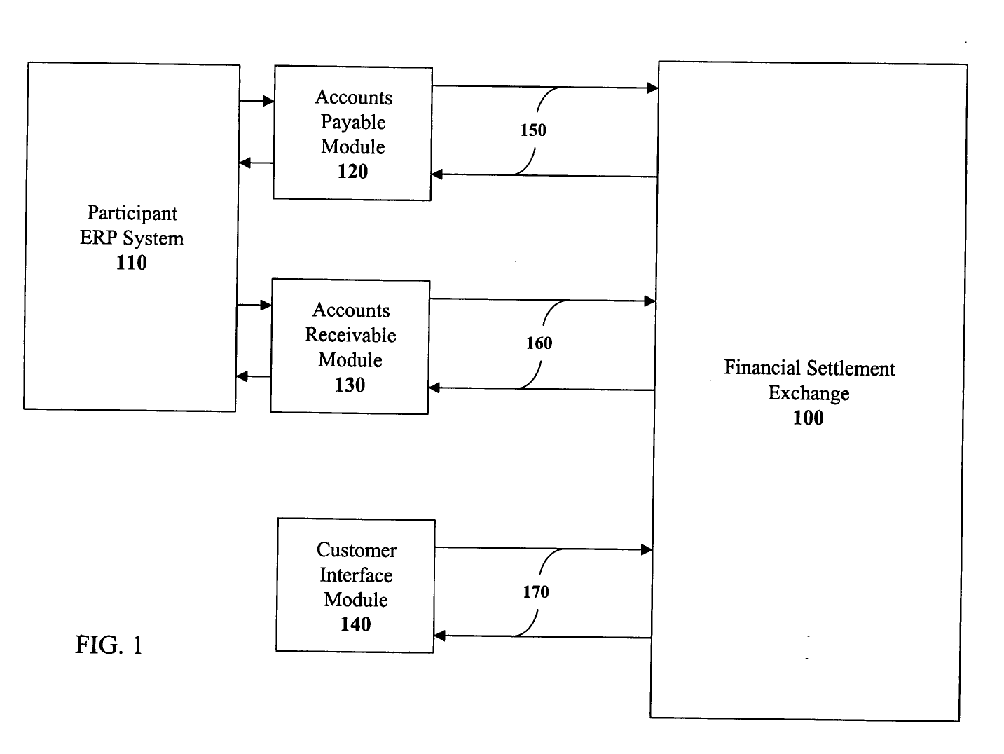

FIG. 1 illustrates two exemplary system interfaces between a participant and financial settlement exchange 100. Participant ERP system 110 can send information to and receive information from exchange 100 via accounts payable module 120, accounts receivable module 130, and communication lines 150 and 160. Alternatively, customer interface module 140 can send information to and receive information from exchange 100 via communication lines 170. Communications lines 150, 160, and 170 can be lines in virtually any type of communications network, such as the Internet, a secure private network, or the public switched telephone network (PSTN).

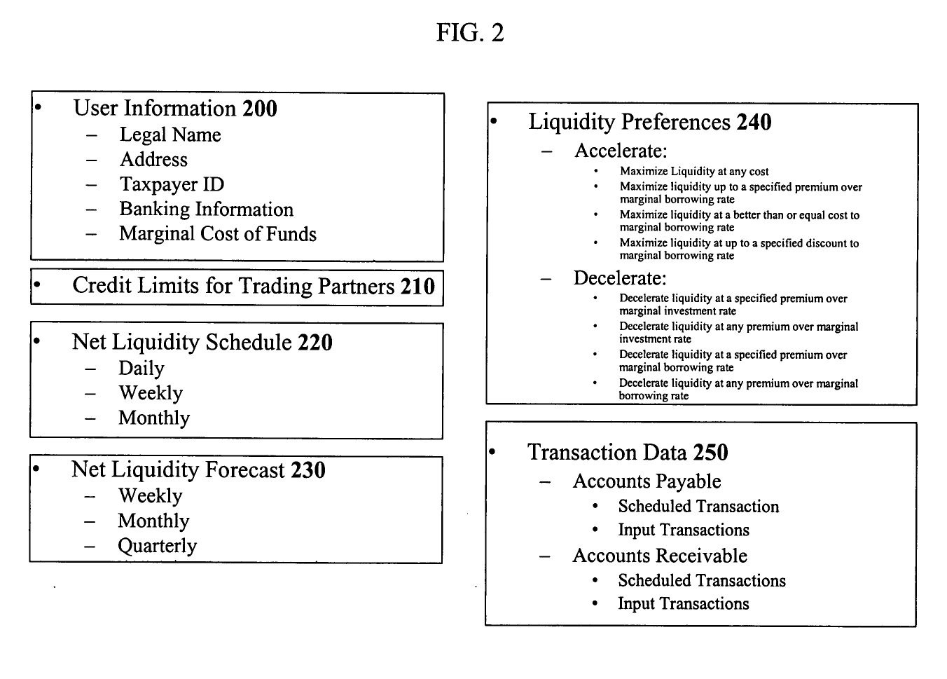

FIG. 2 illustrates exemplary components of the user interface to exchange 100, including panels displaying data about user information 200, credit limits for trading partners 210, net liquidity schedule 220, net liquidity forecast 230, liquidity preferences 240, and transaction data 250 received (and typically stored) by exchange 100.

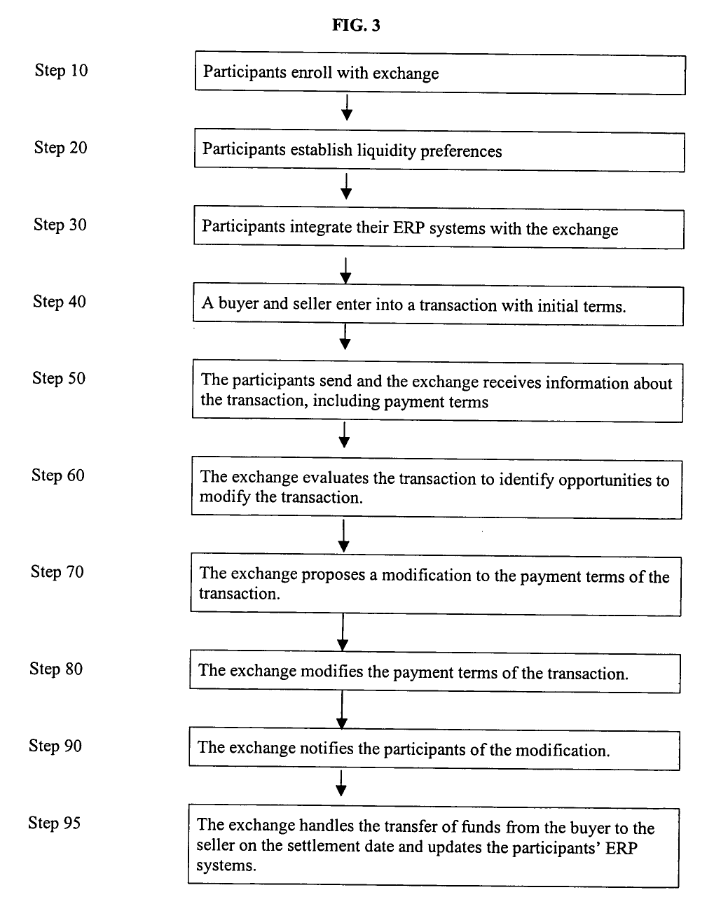

FIG. 3 is a flow chart of an exemplary process for facilitating settlement of transactions between parties with differences in their marginal cost of funds.

At step 10, participants enroll with exchange 100 by providing certain information about themselves and about their credit limits for their trading partners. Exemplary enrollment information received by exchange 100 includes, without limitation:

a. Participant's legal name.

b. Participant's address.

c. A unique enterprise identification code (e.g., a taxpayer ID), specific to a business unit of the participant. A participant may have multiple unique enterprise identification codes, specific to multiple business units.

d. Participant's cost of funds.

e. Participant's banking information, including ABA routing numbers, account numbers, and other information necessary for exchange 100 to direct payments into the appropriate bank account, and debit payments from the appropriate bank account.

f. Credit limits specific to the participant's trading partners. These credit limits may be provided by an automated linkage to the participant's ERP system, or manually key-entered.

Exchange 100 typically stores the enrollment information that it receives in a database. However, this information can be changed as needed by the participants. For example, participants have the ability to adjust terms of trade to optimize the balance between cash flow requirements and financial performance on either a blanket or discrete transaction basis. This can be accomplished by adjusting a participant's registered cost of borrowing with exchange 100.

At step 20, the participants establish their liquidity preferences. Participants have robust abilities to indicate their preferences for accelerating or decelerating cash flows in exchange for decreasing or increasing profits. For example, a participant viewing the liquidity preferences 240 in FIG. 2 could choose a preference for maximizing liquidity at any cost, maximizing liquidity up to a specified premium over the marginal borrowing rate, maximizing liquidity at a better than or equal cost to the marginal borrowing rate, or maximizing liquidity at up to a specified discount to the marginal borrowing rate. These preferences could be expressed for a single day, a range of dates, or until further notice. Conversely, a participant could indicate a preference for decreasing liquidity at a specified premium over the marginal investment rate, decreasing liquidity at any premium over the marginal investment rate, decreasing liquidity at a specified premium over the marginal borrowing rate, or decreasing liquidity at any premium over the marginal borrowing rate. These preferences could be expressed for a single day, a range of dates, or until further notice. A participant can express preferences for either increasing or decreasing liquidity, but not both. A participant can also express a preference to neither increase nor decrease liquidity. Participants have the ability to approve opportunities for transaction modification identified by exchange 100 on an individual or blanket basis. Alternatively, participants can permit exchange 100 to automatically modify the terms of a transaction after an opportunity is identified.

At step 30, the participants integrate their ERP systems with exchange 100. This integration enables exchange 100 to receive details (e.g., payment terms) of transactions that may be eligible for modification. In one embodiment, exchange 100 has standardized interfaces to mainstream ERP packages (e.g., SAP, PeopleSoft, Oracle, or Baan) which allow the participant to upload batch or real time outputs from accounts payable and accounts receivable applications into a secure network, and to download batch or real time inputs from the network. These standardized linkages eliminate the need for customized EDI transaction sets or other regimented protocols, or the need to manually key-enter transaction data. In this embodiment, the participant implements a fully automated integration with exchange 100. As shown in FIG. 1, this integration takes place by integrating certain applications of the participant's ERP system 110 with exchange 100. Most commonly, this integration will occur between the participant's accounts payable module 120 and exchange 100; and between the participant's accounts receivable module 130 and exchange 100.

In another embodiment, the participant can integrate with exchange 100 by manually entering transaction data into exchange 100 via customer interface module 140 associated with exchange 100. In this embodiment, the participant would manually key enter accounts payable and accounts receivable information utilizing customer interface module 140. Additional embodiments representing varying degrees of Electronic Invoice Presentment and Payment (EIPP) automation, which are well known to those of ordinary skill in the art, may also be used.

The networking architecture that connects the participants to exchange 100 (illustrated schematically by communications links 150, 160, and 170 in FIG. 1) need not be described in detail because such networks (e.g., the Internet, a secure private network, or the PSTN) are well known to those of ordinary skill in the art.

In step 40, a buyer and a seller enter into a transaction with initial payment terms. For example, a buyer purchases $1.0 million in goods or services from a seller, and agrees to pay the seller 30 days after receipt of a valid invoice.

In step 50, the participants (i.e., the buyer and the seller) send and exchange 100 receives information about the transaction, including payment terms.

In step 60, exchange 100 evaluates the transaction to identify opportunities to modify the payment terms of the transaction. The initial terms of the transaction must match (i.e., the terms and amounts must be consistent between the data received from the buyer and the data received from the seller). Exchange 100 determines whether the transaction is eligible for modification based on a number of factors. These factors include the respective cost of funds of the buyer and seller and the terms of payment. In addition, the liquidity preferences of the buyer and seller, the credit limits established by the seller, and the credit quality of the seller are typically evaluated.

In step 70, exchange 100 proposes a modification to one or more payment terms if it determines that the transaction is eligible for modification. In some embodiments, such as a fully automated system, this step may be omitted if the buyer and seller have previously consented to having exchange 100 make the modifications automatically.

Many methods can be used to allocate the financial benefit of a transaction modification among the buyer, the seller, and exchange 100. Typically, there will be an inverse relationship between the relative cost of funds of a participant and the proportional benefit received from a transaction modification. In other words, the party with stronger credit will generally enjoy more of the benefit associated with a transaction modification.

This inverse relationship may be superceded, however, if permitted by the liquidity preferences of the participants. For example, a seller with a high cost of funds relative to a buyer may express a liquidity preference that authorizes transaction modification only when the resultant cost is substantially lower than the seller's cost of funds. If the buyer expresses a liquidity preference that authorizes a transaction modification at any rate better than or equal to its cost of funds, there is an opportunity for the seller to enjoy a substantial share of the overall benefit associated with a transaction modification.

Exchange 100 will also earn fees for its services. These fees could be a percentage of the financial benefit of a transaction modification and/or a fixed fee. For example, the financial benefit could be split 80/10/10 among the strong participant, weak participant, and exchange 100, respectively. Alternatively, exchange 100 could receive a fixed fee, with the remaining financial benefit split 90/10 between the strong participant and the weak participant. Many other allocation methods, which are well known to those of ordinary skill in the art, are possible.

In step 80, exchange 100 modifies the terms of the transaction. In some embodiments, this step is performed by the buyer and seller, rather than by the exchange 100.

In step 90, exchange 100 notifies the participants of the modification. If the participants have integrated their ERP systems with exchange 100, the participants' ERP systems are updated by exchange 100 with the modified payment terms.

In step 95, in some embodiments, exchange 100 handles the transfer of funds from the buyer to the seller on the settlement date and updates the participants' ERP systems.

To further describe the process of the present invention, three different exemplary scenarios that may be encountered when using exchange 100 will be described: (1) the strong buyer/weak seller, (2) the weak buyer/strong seller, and (3) the forfait scenario.

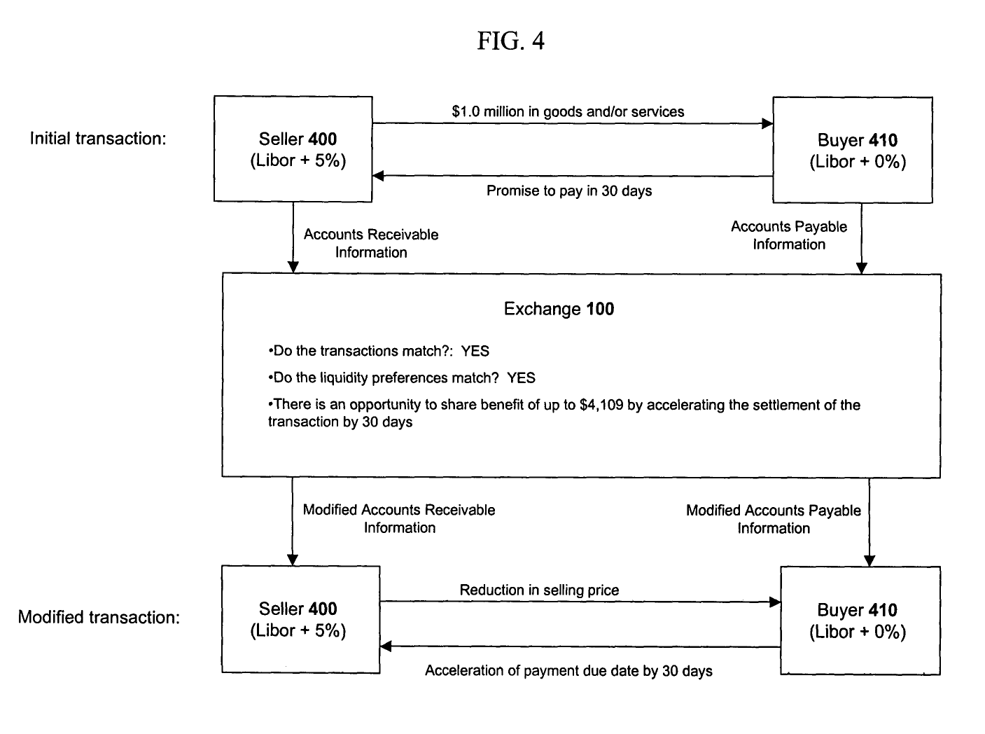

FIG. 4 is a schematic diagram illustrating the flow of information and finds between participants and exchange 100 for the strong buyer/weak seller scenario.

In this example, an investment grade buyer 410 with a (LIBOR+0%) borrowing rate is purchasing goods or services worth $1.0 million dollars from a sub-investment grade seller 400 with a (LIBOR+5%) borrowing rate, with payment due in 30 days. Thus, there is an opportunity to share the differential ($1.0 million×5%×30/365=$4,109.59) such that both participants benefit, even after deducting a small clearing spread earned by exchange 100.

After entering into a transaction with initial terms, seller 400 and buyer 410 upload transaction information to exchange 100. As previously discussed, this upload can be accomplished in a fully automated fashion, a semi-automated fashion, or a manual fashion.

After receiving the uploads from the respective participants, exchange 100 evaluates the transaction to determine whether it is eligible for modification. Exchange 100 determines whether the uploaded transactions match with respect to trading partner IDs, amount, due date, invoice number, and other payment and remittance information. In the example shown in FIG. 4, the uploaded transactions match. If the uploaded transactions did not match, the problem would be communicated to the participants for research and resolution.

Exchange 100 also determines whether the liquidity preferences match. In the example at hand, seller 400 wishes to receive accelerated payment in exchange for a reduction in price, and buyer 410 is willing to pay faster in exchange for a reduction in price. Thus, the liquidity preferences match.

Exchange 100 evaluates the benefit available to be shared between buyer 410, seller 400, and exchange 100 by modifying the payment terms of the transaction. In the example shown in FIG. 4, the benefit is $4,109, which is calculated by multiplying the amount owed ($1.0 million dollars) by the difference in cost of finds between seller 400 and buyer 410 (5%), by the time reduction in days (30) divided by 365 days per year.

After evaluating the transaction, exchange 100 proposes to the participants that the payment terms be modified by reducing the price and accelerating the payment due date. This proposal can be fully automated, semi-automated, or manual. In this example, buyer 410 (payor) would increase profits by reducing expense by a greater amount than the cost of funds incurred as a result of paying the seller faster. The seller (payee) would increase profits by reducing expense (e.g., cost of sales, interest expense) by an amount greater than the discount on the selling price. In addition, exchange 100 would receive a fee for identifying the modification opportunity and/or implementing the modification.

In this example, because the buyer is strong and the seller is weak, the payment terms would be modified such that the financial benefit of $4,109 is split 80/10/10 among the strong buyer, weak seller, and exchange 100, respectively. For example, the selling price would be reduced by $3287 (i.e., 80% of $4109), payment would be accelerated by 30 days, and exchange 100 would receive a fee of $411 (i.e., 10% of $4109).

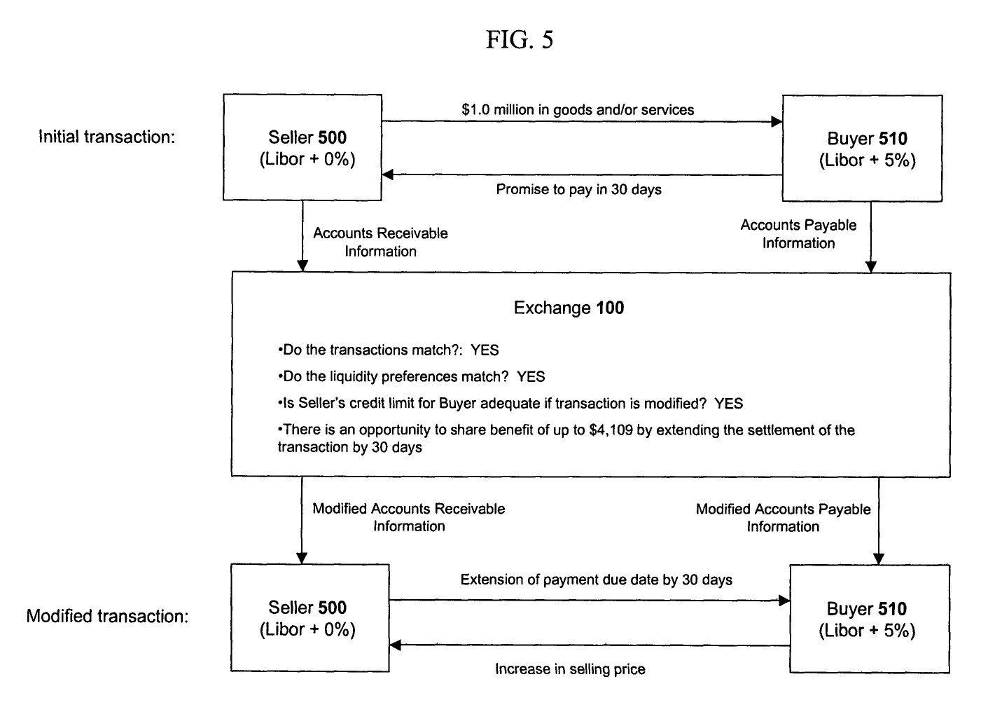

FIG. 5 is a schematic diagram illustrating the flow of information and funds between participants and exchange 100 for the weak buyer/strong seller scenario.

In this example, an investment grade seller 500 with a (LIBOR+0%) borrowing rate is selling goods or services worth $1.0 million dollars to a sub-investment grade buyer 510 with a (LIBOR+5%) borrowing rate, with payment due in 30 days. Thus, there is an opportunity for the participants to benefit by modifying the transaction by extending the due date of the payment in exchange for an increase in the selling price.

After entering into a transaction with initial terms, the seller 500 and buyer 510 upload transaction information to exchange 100. As previously discussed, this upload can be accomplished in a fully automated fashion, a semi-automated fashion, or a manual fashion. After receiving the uploads from the respective participants, exchange 100 evaluates the transaction to determine whether it is eligible for modification. Exchange 100 determines whether the uploaded transactions match with respect to trading partner IDS, amount, due date, invoice number, and other payment and remittance information. In the example shown in FIG. 5, the uploaded transactions match. If the uploaded transactions did not match, the problem would be communicated to the participants for research and resolution.

Exchange 100 also determines whether the liquidity preferences match. In the example at hand, seller 500 wishes to extend the payment due date in exchange for an increase in price, and buyer 510 wishes to pay in 60 days rather than 30 days in exchange for an increase in price. Thus, the liquidity preferences match.

Exchange 100 evaluates the credit limit that seller 500 has set for buyer 510, to determine that an extension in date or increase in the amount is within the credit limit. In this example, the credit limit will not be exceeded by modifying the payment terms.

Exchange 100 evaluates the benefit available to be shared between buyer 510, seller 500, and exchange 100 by modifying the payment terms of the transaction. In the example shown in FIG. 5, the benefit is $4,109, which is calculated by multiplying the amount owed ($1.0 million dollars) by the difference in cost of funds between buyer 510 and seller 500 (5%), by the time extension in days (30) divided by 365 days per year.

After evaluating the transaction, exchange 100 proposes to the participants that the payment terms be modified by increasing the price and extending the due date. This instruction can be fully automated, semi-automated, or manual. In this embodiment, buyer 510 (payor) would increase profits by reducing expense (e.g., interest expense) by a greater amount than the increased purchase price incurred as a result of paying seller 500 30 days later than the original terms. Seller 500 (payee) would increase profits by increasing the purchase price by an amount greater than the cost of funds incurred as a result of receiving payment 30 days later than the original terms. In addition, exchange 100 would receive a fee for identifying the modification opportunity and/or implementing the modification.

In this example, because the buyer is weak and the seller is strong, the payment terms would be modified such that the financial benefit of $4,109 is split 10/80/10 among the weak buyer, strong seller, and exchange 100, respectively. For example, the selling price would be increased by $3287 (i.e., 80% of $4109), payment would be extended by 30 days, and exchange 100 would receive a fee of $411 (i.e., 10% of $4109).

If a participant expressed a desire to accelerate liquidity, but lacked an agreeable counterparty participant, exchange 100 can offer a forfait option. The forfait option allows the initiating participant the option of selling designated, qualified receivables on a non-recourse basis to exchange 100, a company affiliated with exchange 100, or a company not affiliated with exchange 100. The sales price would be a discount to the face value of the receivable, with the discount based in part on the credit rating of the seller, the credit rating of the payor, and the due date of the receivable. Once again, even after allowing for a transaction spread to be deducted by exchange 100, the participants would benefit by being able to precisely control daily liquidity in a fashion that increases the profitability of the entity.

The various embodiments described above should be considered as merely illustrative of the present invention. They are not intended to be exhaustive or to limit the invention to the forms disclosed. Those skilled in the art will readily appreciate that still other variations and modifications may be practiced without departing from the general spirit of the invention set forth herein. Therefore, it is intended that the present invention be defined by the claims that follow.

What is claimed is:

1. A method for modifying the payment terms of a transaction between a buyer and a seller, comprising:
at a computerized financial settlement exchange,
receiving a buyer's cost of funds and one or more liquidity preferences, a seller's cost of funds and one or more liquidity preferences, and one or more payment terms of a transaction, wherein said buyer's cost of finds is specified by said buyer and said seller's cost of funds is specified by said seller;
determining whether said transaction is eligible for modification based at least in part on said buyer's cost of finds and one or more liquidity preferences, said seller's cost of funds and one or more liquidity preferences, and said one or more payment terms;
proposing a modification to said one or more payment terms if said determining step finds that said transaction is eligible for modification; and
modifying said one or more payment terms in said transaction without financial intervention by a third party.

2. A method for facilitating the modification of payment terms in a transaction between a buyer and a seller, comprising:
at a computerized financial settlement exchange,
receiving a buyer's cost of funds, a seller's cost of funds, and one or more payment terms of a transaction;
determining whether said transaction is eligible for modification based at least in part on said buyer's cost of funds, said seller's cost of funds, and said one or more payment terms; and
proposing a modification to said one or more payment terms if said determining step finds that said transaction is eligible for modification.

3. The method of claim 2, further comprising receiving in said financial settlement exchange costs of finds from a plurality of sellers.

4. The method of claim 2, further comprising receiving in said financial settlement exchange costs of funds from a plurality of buyers.

5. The method of claim 2, further comprising receiving in said financial settlement exchange costs of funds from a plurality of buyers and sellers.

6. The method of claim 2, further comprising receiving in said financial settlement exchange one or more liquidity preferences from said buyer.

7. The method of claim 6, further comprising determining whether said transaction is eligible for modification based at least in part on said buyer's one or more liquidity preferences.

8. The method of claim 2, further comprising receiving in said financial settlement exchange one or more liquidity preferences from said seller.

9. The method of claim 8, further comprising determining whether said transaction is eligible for modification based at least in part on said seller's one or more liquidity preferences.

10. The method of claim 2, further comprising receiving in said financial settlement exchange liquidity preferences from a plurality of buyers and sellers.

11. The method of claim 2, further comprising modifying said one or more payment terms in said transaction.

12. The method of claim 11, wherein said modifying step does not involve financial intervention by a third party.

13. The method of claim 2, wherein said exchange is part of the buyer.

14. The method of claim 2, wherein said exchange is part of the seller.

15. The method of claim 2, wherein said exchange is not part of the buyer or the seller.

16. The method of claim 2, wherein said buyer's cost of funds is specified by said buyer and said seller's cost of funds is specified by said seller.

17. A method for modifying the payment terms of a transaction between a buyer and a seller, comprising:
at a computerized financial settlement exchange,
receiving a buyer's cost of funds, a seller's cost of funds, and one or more payment terms of a transaction;
determining whether said transaction is eligible for modification based at least in part on said buyer's cost of funds, said seller's cost of funds, and said one or more payment terms; and
modifying said one or more payment terms in said transaction if said determining step finds that said transaction is eligible for modification.

18. A method for facilitating the modification of payment terms in a transaction between participants, comprising:
sending one or more payment terms of a transaction between a first participant and a second participant to a computerized financial settlement exchange configured to determine whether said transaction is eligible for modification based at least in part on said first participant's cost of funds, said second participant's cost of funds, and said one or more payment terms; and
receiving a proposal from said exchange to modify said one or more payment terms in said transaction if said exchange determines that said transaction is eligible for modification.

19. A method for modifying the payment terms of a transaction between participants, comprising:
sending one or more payment terms of a transaction between a first participant and a second participant to a computerized financial settlement exchange configured to:
determine whether said transaction is eligible for modification based at least in part on said first participant's cost of funds, said second participant's cost of funds, and said one or more payment terms; and
modify said one or more payment terms in said transaction if said exchange determines that said transaction is eligible for modification; and
receiving from said exchange notification of said modification.

20. A financial settlement exchange system comprising at least one computer,
wherein said at least one computer
receives a buyer's cost of funds, a seller's cost of funds, and one or more payment terms of a transaction;
determines whether said transaction is eligible for modification based at least in part on said buyer's cost of funds, said seller's cost of funds, and said one or more payment terms; and
proposes a modification to said one or more payment terms if said determination finds that said transaction is eligible for modification.

21. A financial settlement exchange system comprising at least one computer,
wherein said at least one computer
receives a buyer's cost of funds, a seller's cost of funds, and one or more payment terms of a transaction;
determines whether said transaction is eligible for modification based at least in part on said buyer's cost of funds, said seller's cost of funds, and said one or more payment terms; and
modifies said one or more payment terms if said determination finds that said transaction is eligible for modification.

22. A machine readable medium having stored thereon data representing sequences of instructions, which when executed by a computerized financial settlement exchange, cause said exchange to execute a method for facilitating the modification of payment terms in a transaction between a buyer and a seller, the method comprising:
receiving a buyer's cost of funds, a seller's cost of finds, and one or more payment terms of a transaction;
determining whether said transaction is eligible for modification based at least in part on said buyer's cost of funds, said seller's cost of finds, and said one or more payment terms; and
proposing a modification to said one or more payment terms if said determining step finds that said transaction is eligible for modification.

23. A machine readable medium having stored thereon data representing sequences of instructions, which when executed by a computerized financial settlement exchange, cause said exchange to execute a method for modifying the payment terms of a transaction between a buyer and a seller, the method comprising:
receiving a buyer's cost of funds, a seller's cost of funds, and one or more payment terms of a transaction;
determining whether said transaction is eligible for modification based at least in part on said buyer's cost of funds, said seller's cost of funds, and said one or more payment terms; and
modifying said one or more payment terms if said determining step finds that said transaction is eligible for modification.
